(19) United States
(12) Patent Application Publication
(10) Pub. No.: US 2016/0279567 A1
(43) Pub. Date: Sep. 29, 2016

(54) HYDRATED LIME COMPOSITION FOR FLUE GASES TREATMENT

(71) Applicant: NEW LIME DEVELOPMENT SPRL, Villers-le-Bouillet (BE)

(72) Inventor: Philippe Dumont, Saint-Georges-sur-Meuse (BE)

(73) Assignee: NEW LIME DEVELOPMENT SPRL

(21) Appl. No.: 15/177,579

(22) Filed: Jun. 9, 2016

Related U.S. Application Data
(63) Continuation-in-part of application No. PCT/BE2014/000067, filed on Dec. 9, 2014.

(30) Foreign Application Priority Data
Dec. 10, 2013 (BE) 2013/0822

(51) Int. Cl. B01D 53/82; B01D 53/50; B01J 20/30; B01J 20/04; B01J 20/28

(52) U.S. Cl. CPC B01D 53/82; B01J 20/041; B01J 20/043; B01J 20/046; B01J 20/045; B01J 20/28059; B01J 20/28071; B01J 20/28016; B01J 20/3028; B01D 53/508

(57) ABSTRACT

The present invention relates to a hydrated-lime-based composition, to a method for producing such a composition and to the use thereof for treating fumes or flue gases (by means of a dry or substantially dry treatment process), in particular to reduce the chlorine, sulphur and halogen compounds in exhaust gases or flue gases, especially acid flue gases. Said composition comprise a high surface area hydrated lime, a first additive selected from NaCl, Na₂SO₄ and CaCl₂, a sodium compound selected from NaOH, Na₂CO₃ and NaI— and less than 5% by weight water.

### CROSS-REFERENCE TO RELATED APPLICATIONS

The present application is a continuation-in-part application of PCT application PCT/BE2014/000067 filed on Dec. 9, 2014, published on Jun. 18, 2015 under the number WO2015/085375, and claiming the priority of Belgian patent application BE2013/0822 filed on Dec. 10, 2013, now Belgian Patent BE1021753 granted on Jan. 15, 2016.

### THE STATE OF THE ART

Pulverulent hydrated lime, which is also referred to as slaked lime, is understood to mean a mass of solid particles, primarily consisting of calcium hydroxide Ca(OH)₂. Said slaked lime can of course contain impurities, such as magnesium oxide or hydroxide, silica, alumina etc. in the amount of several dozen grams per kilo. In a general manner, the size of the particles of this pulverulent material is wholly less than 1 mm and often less than 250 μm. The slaked lime can contain free water, that is to say water which is not chemically bonded to the compound, up to approximately 50 g/kg.

The deacidification of the fumes from incinerators or coal-fired power stations is essentially carried out in three separate ways, that is to say the wet process, the dry process and the semi-dry process.

In the treatment using the wet or semi-dry process, the fumes are placed in contact with a solution or suspension containing calcium hydroxide or ground limestone. The major disadvantages of this treatment include the preparation of the solution or suspension, but also the treatment of residual sludge. In addition, this type of method requires significant investment.

In order to avoid the problems of treatment using the wet or semi-wet process, it has been proposed to treat the fumes using the dry process. In such a treatment, the absorption agents are injected into the fumes in the dry or pulverulent state.

The use of pulverulent soda, sodium carbonate or sodium bicarbonate in the treatment using the dry process is very effective, but has two major disadvantages, that is to say the cost and the treatment of residual sodium salts, given the high solubility thereof.

It has also been proposed to use ground limestone and slaked lime in the method using the dry process. In such a treatment, the rate of the use of the agent was low, in particular given the low reactivity and the short period of contact between gas and solid.

Numerous studies have been carried out in order to improve the rate of use of the lime. It has been found that in order to meet the pollution standards, it is necessary to use a greatly excessive amount of hydrated lime with respect to the amount required in the case of total stoichiometric reaction.

It has thus been proposed to modify calcium hydroxide, for example as described in EP558522 or U.S. Pat. No. 5,306,475.

As described in WO2007/000433 (now U.S. Pat. No. 7,744,678), “the pulverulent slaked lime is used in numerous applications, in particular to neutralise acid compounds (HCl, SO₂, HF, SO₃ etc.) which are present in exhaust gases. In this method using the “dry process”, which is simple and inexpensive, the pulverulent lime, which is used as an absorbent, is placed in direct contact with the gases to be purified. However, the neutralisation reaction between gas and solid material is not easy, and a significant excess of calcium reagent is often required with respect to the amount of acid to be neutralised in order to meet the increasingly restrictive emission standards. This excess of reagent above all poses the problem of additionally generating by-products or residues which are to be processed downstream. In order to reduce the excess of reagent or absorbent to be used, numerous products based on pulverulent slaked lime have been developed so as to achieve an improved capacity to capture acid gases using the dry process. In particular, it is known to support the capture of HCl gas using conventional slaked limes, by combining said limes with an additive, such as alkaline hydroxides or carbonates or alkaline chlorides [CHEN, D. et coll., International Academie Publishers, 1999, pp, 337-342]. In this document, the additive in question is added to the water for slaking the quick lime during the preparation of the hydrated lime. The authors observe an improvement in the performance of reducing HCl gases in the slaked lime thus obtained, with respect to the absence of additive, at application temperatures of greater than 200° C. By contrast, there is no effect on the reduction of SO₂.”

Still according to WO2007/000433 (now U.S. Pat. No. 7,744,678 in the name of Lhoist, one of the leaders in the hydrated lime, if not the leader), “other works, such as presented in U.S. Pat. No. 4,604,269, recommend adding, to the water for slaking the quick lime, additives such as sodium hydroxide (NaOH) in the amount of 5% to 10% by weight, with respect to the quick lime, or even chlorides, such as calcium chloride (CaCl₂). The slaked lime thus obtained promotes the desulphurisation of the fumes at “low” temperature, that is to say less than 230° C., and preferably less than 175° C. The effect of the additive becomes apparent when the application temperature of the absorbent differs from the dew point by less than 25° C., preferably by less than 10° C. In these conditions, the additive has the result of rendering the absorbent deliquescent in the presence of moisture, and this promotes the presence of a liquid film at the interface between solid and gas and improves the capture of SO₂.”

Still according to WO2007/000433, the following is specified with regard to the prior art:
“WO 88/09203 incorporates this concept of adding an alkaline compound, such as NaOH or chlorides such as CaCl₂, to the water for slaking quick lime. The amounts and the effect of these additives are not really commented on. The first would have the role of increasing the alkalinity of the absorbent, the second of retaining water, as in the case of U.S. Pat. No. 4,604,269 mentioned above,
The document [Method for producing reactive Coolside sorbent—Production of reactive sorbent for cool-size process—by hydrating quicklime with water containing sodium chloride aqueous solution, Research Disclosure, 1988, 295(898), No. 29564, ISSN: 03744353] confirms the positive effect on the desulphurisation in conditions which are close to saturation (preferably less than 20° C. above the dew point) of additives such as Na₂CO₃, NaOH, CaCl₂ and in particular NaCl, which are present in an amount of more than 5% by weight of the adsorbent, by addition to the slaking water. However, the slaked lime modified in this way has a BET specific surface area which is less than that of the conventional hydrated lime, which is obtained in the absence of additive. In the application conditions studied, the use of organic additives, such as sugars and surfactants, does not improve the desulphurisation of the slaked limes.
It has been provided in this case to qualify as “first generation” the absorbents from the prior art which are based on slaked lime, the capacity of which to capture acid gases has been improved with respect to a “conventional” or “standard” slaked lime by adding an additive of the type of those mentioned above, that is to say a modification by “chemical” means.
There is another class of absorbents based on slaked lime, the capacity of which to capture acid gases is greater than that of a conventional hydrated lime. The advantage of these absorbents thus comes from a modification of the physical properties, in this case the texture, that is to say a greater BET specific surface area and/or a greater BJH pore volume. These absorbents will be qualified as “second generation”, produced by a modification by “physical” means; see [OATES, J. A. H., Lime and limestone, Weinheim: Wiley-VCH, 1998, 455, pp. 219-221]. For example, WO97/14650 discloses a composition of pulverulent lime comprising particles of calcium hydroxide having a BET specific surface area of greater than 25 m²/g and a BJH total pore volume for desorption to nitrogen of at least 0.1 cm³/g.
This document describes in particular a product based on hydrated lime, the BJH pore volume and the BET specific surface area of which are clearly more developed than those of a standard calcium hydroxide. The capacity to capture acid gases of a hydrated lime of this type is clearly improved with respect to a conventional hydrated lime, but also with respect to a first generation slaked lime. The second generation hydrated lime according to the international patent application WO97/14650 is currently considered to be the most effective calcium reagent for the capture of acid gases using the dry process, in a wide range of operating conditions.”

WO2007/000433 (now BE101661, EP1896364) recommends a pulverulent lime of more than 25 m²/g, further comprising an alkaline metal in an amount of less than 3.5% by weight. Although the document suggests an ineffectiveness in treatment with a content of alkaline metal of more than 3.5% by weight, Table 5 of this document (WO2007/000433, and its European equivalent as well as its Belgian priority document) discloses that a second generation lime (WO97/14650) with NaOH added in an amount of 50 g/kg is ineffective. A content of 50 g/kg of NaOH corresponds to an alkaline metal content of (23/40)×50 g per kg, or a content of 2.875% alkaline metal in the composition.

By repeating the embodiments of WO 2007/000433 (now U.S. Pat. No. 7,744,678) using the preferred method, it was not possible to achieve an effective treatment of the fumes, with a high rate of use of the lime.

The use of a hydrated lime with an addition of 5% by weight of sodium carbonate or bicarbonate has already been tested by the US Environmental Protection Agency, “Performance of Sorbents with and without additives, injected into a small innovative furnace”, Rakes et al, 1st Joint Symposium on Dry SO₂ and simultaneous SO₂/NO_{X} Control Technologies, San Diego, Calif., Nov. 13, 1984.

The conclusions of this report are that the use of sodium carbonate or bicarbonate in an amount of 5% by weight of the absorbent based on calcium (calcium hydroxide, calcium and magnesium hydroxide and calcium carbonate) improves the capture of sulphur. However, this document stipulates that the capture of SO₂ by calcium hydroxide is not greatly improved by the use of these additives (sodium carbonate or bicarbonate).

During the treatment of fumes using the dry process by means of pulverulent dry hydrated lime having a specific surface area of approximately 15 to 20 m²/g, it was noted that the rate of use of the lime was only approximately 10% in an industrial method. Consequently, it is necessary to inject a great excess of pulverulent lime into the fumes to meet the current emission standards. Thus, industrially, with respect to the SO₂ and HCl present in the fumes, it was required to inject an amount of lime equal to 3.5 to 6.5 times the amount of lime which would have been necessary in the case of a complete stoichiometric reaction. (In the current submission, rate of use is understood to mean the amount of hydrated lime, expressed in %, which has reacted with the SO₂ or HCl to form calcium sulphites, sulphates or chlorides.)

U.S. Pat. No. 4,767,605 (Lindbauer et al) discloses a method for treating fumes by means of absorbents which can comprise for example NaHCO₃, NH₄HCO₃, Al(OH)₃, silica gel, Ca(OH)₂, salts comprising water of crystallisation such as CaCl₂ or Al₂O₃. As well as emerging from the description and the claims of this document, the method is essentially based on the use of sodium bicarbonate to release carbon dioxide to form an active absorbent. The document discloses that the mixture of hydrated lime containing chloride is prepared by slaking quick lime in the presence of hydrochloric acid (see column 5 lines 29 to 37) for achieving according to Lindbauwer et al Ca(OH)₂ intermixed with chlorides for preventing reaction only on the surface of the absorbent. Test carried by the inventor has proved that this leads to a hydrated lime having a very low specific surface area. This document does not describe a mixture comprising a hydrated lime having a large specific surface area, associated with an additive and a sodium compound allowing an improved rate of use of the hydrated lime, combined with greater effectiveness of the desulphurisation and dechlorination treatment. U.S. Pat. No. 4,767,605 neither describes nor suggests a composition which makes it possible to obtain such results.

JP2002-114543 (Yoshizawa Lime Industry) discloses a method of manufacturing an high reactive calcium hydroxide useful for treating fumes. The highly reactive calcium hydroxide is prepared by a wet-slaking method in presence of organic compound (like citric acid, sorbitol, followed by a filtration under pressure and a drying step with hot gases. As stated in said documents, various efforts are made. Table 2 of this document shows that the presence of additives can improve the capture of HCl and SO₂ even in comparison with a hydrated lime with a specific surface area of 40 m²/g.

WO92/09528 discloses the use of diethyleneglycol or diethyleneamine during the slaking of quicklime for achieving after drying a hydrate lime with a specific surface area of more than 35 m²/g

DE3826971 (Fichtel) discloses a process for preparing a modified calcium hydroxide by adding in the slaking water additives like sodium hydroxide, magnesium chloride, calcium chloride, sodium bicarbonate, aluminium sulphate, iron chloride, iron sulphate, etc.

DE3716566 and U.S. Pat. No. 5,306,475 disclose an “enhanced calcium hydroxide” by slacking the quicklime in presence of additive of coke, activated carbon, aluminium oxide, iron chloride, sodium bicarbonate, calcium chloride, etc. When comparing examples 1 to 3, it appears that the addition of calcium chloride to the slacking water had a quite limited efficiency improvement for the HCl absorption (23.7%) with respect to the absorption (21.1%) achieved with hydrated lime obtained by slacking quicklime without additive or with respect to the absorption (33%) achieved with hydrated lime achieved in presence of Iron Chloride.

JP2010-227865 discloses the treatment of exhaust gases treated independently in two distinct treatment steps: first treatment step with a calcium based neutralising agent, and second treatment step with a sodium based neutralising agent.

U.S. Pat. No. 4,604,269 discloses the use of calcium hydroxide prepared by slaking quicklime with a solution containing sodium hydroxide, for treating flue gases.

U.S. Pat. No. 4,552,767 also discloses an absorbent of CO₂ comprising calcium hydroxide, sodium or potassium hydroxide and optionally calcium chloride. This document neither describes the use of hydrated lime having a large specific surface area, nor suggests a composition allowing a greater rate of use of the hydrated lime in the treatment of fumes with respect to the rate achieved by means of a hydrated lime having a large specific surface area.

As it can be seen main research and major efforts are still made for improving the treatment of flue gases, by using in a more efficient way the treatment agent.

Contrary to various statements in the prior art, it has been observed that the performance of capture of SO₂ was not or substantially not effectively improved by adding to the slaking water additives like sodium hydroxide, sodium bicarbonate, sodium sulphate, sodium chloride, etc.

It is now noted that the performance of the capture of SO₂ by using a dry or substantially dry calcium hydroxide capturing agent could still be improved by combining with a hydrated lime having a large specific surface area two different additives (first hygroscopic additive like chlorinated sodium and sodium sulphate additives, second additive like sodium hydroxide or sodium bicarbonate) which are added at the end of the slaking step or after the slaking step. The composition according to the invention has proven to allow excellent capture of chlorinated compounds of fumes, but also other compounds which are present in the fumes, whilst ensuring an excellent rate of use of calcium hydroxide for the capture of acid compounds which are present in the fumes.

### BRIEF DESCRIPTION OF THE INVENTION

The invention relates to a composition (dry or substantially dry) for treating fumes (or flue gases, especially acid flue gases comprising HCl and/or SO₂), comprising:
more than 80% by weight of hydrated lime in the form of particles of calcium hydroxide having a BET specific surface area which is equal to or greater than 25 m²/g, advantageously more than 30 m²/g, and a BJH total pore volume which is equal to or greater than 0.1 cm³/g;
a first additive selected from the group consisting of NaCl, Na₂SO₄, CaCl₂ and the mixtures thereof, the ratio by weight of said first additive to hydrated lime (in the form of particles of calcium hydroxide having a BET specific surface area which is equal to or greater than 25 m²/g, advantageously more than 30 m²/g, and a BJH total pore volume which is equal to or greater than 0.1 cm³/g) being greater than 1:100, advantageously between 1:100 and 1:10, preferably between 1:50 and 1:20,
at least 1% by weight, advantageously from 1 to 10% by weight, preferably from 1 to 5% by weight of a second additive selected from NaOH, Na₂CO₃, NaHCO₃ and the mixtures thereof, and
less than 5% by weight, advantageously less than 3% by weight of water, preferably less than 1% by weight.

More specifically, the composition comprises as first additive at least NaCl, and as second additive at least Na₂CO₃, and even basic Na₂CO₃.

Most preferably, the composition comprises substantially only NaCl as first additive and Na₂CO₃ and/or NaHCO₃ as second additive.

In particular, at least 98% by weight, advantageously 99% by weight of the composition according to the invention consists of hydrated lime (in the form of particles of calcium hydroxide having a BET specific surface area which is equal to or greater than 25 m²/g, advantageously more than 30 m²/g, and a BJH total pore volume which is equal to or greater than 0.1 cm³/g), NaCl, Na₂CO₃ and/or NaHCO₃ and water.

According to a more preferred embodiment, at least 98% by weight, advantageously 99% by weight of the composition consists of hydrated lime, NaCl, Na₂CO₃ and water.

According to an advantageous embodiment, the ratio by weight of first additive+second additive (sodium compound selected from NaOH, Na₂CO₃, NaHCO₃ and the mixtures thereof) to hydrated lime is greater than 1:50, advantageously greater than 1:20, preferably between 1:20 and 4:20, more specifically between 2:20 and 3:20.

According to distinctive features of one embodiment, the composition has one or more of the following distinctive features:
the particles of calcium hydroxide have an average size by weight of less than 100 μm, and/or
the composition is at least partially in the form of grains having an average size by weight of between 0.5 mm and 7 mm, and/or
the composition is in the form of a mixture of calcium hydroxide particles having an average size by weight of less than 100 μm and of grains having an average size by weight of from 0.5 mm to 7 mm, and/or.
the calcium hydroxide particles having a BET specific surface area which is equal to or greater than 25 m²/g and a BJH total pore volume which is equal to or greater than 0.1 cm³/g are prepared by slaking quick lime with water free of first additive and free of second additive for achieving slacked lime and by drying said slacked lime for achieving calcium hydroxide particles with a water content of less than 5% by weight, and/or.
the calcium hydroxide particles having a BET specific surface area which is equal to or greater than 25 m²/g and a BJH total pore volume which is equal to or greater than 0.1 cm³/g have an outer surface, and in which at least 50% by weight of the first additive and at least 50% by weight of the second additive are contacting the outer surface of the said calcium hydroxide particles, and/or
the calcium hydroxide particles having a BET specific surface area which is equal to or greater than 25 m²/g and a BJH total pore volume which is equal to or greater than 0.1 cm³/g comprises from 0.1% to 2% by weight (advantageously from 0.1 to 1% by weight, preferably from 0.1% to 0.5% by weight) diethyleneglycol and/or triethanolamine. (the said calcium hydroxide particles being prepared by slaking quicklime in presence of diethyleneglycol and/or triethanolamine)

The invention also relates to a method for preparing a composition according to the invention as disclosed hereabove.

The method of the invention is a method for preparing a dry or substantially dry composition for treating fumes as disclosed here above, comprising:
more than 80% by weight of hydrated lime in the form of particles of calcium hydroxide having a BET specific surface area which is equal to or greater than 25 m²/g and a BJH total pore volume which is equal to or greater than 0.1 cm³/g;
a first additive selected from the group consisting of NaCl, Na₂SO₄, CaCl₂ and the mixtures thereof, the ratio by weight of said first additive to hydrated lime being comprised [ ] between 1:100 and 1:10, preferably between 1:50 and 1:20,
at least 1% by weight, advantageously from 1 to 10% by weight, preferably from 1 to 5% by weight of a second additive selected from the group consisting of NaOH, Na₂CO₃, NaHCO₃ and the mixtures thereof, and
less than 5% by weight water,
   whereby said water content of less than 5% by weight is achieved by at least a drying step, and
   whereby said method comprises at least the following preparation steps of:
preparing a calcium hydroxide composition consisting for more than 99% by weight of calcium hydroxide and water, said calcium hydroxide composition being substantially free of said first additive and said second additive, said calcium hydroxide composition having a moisture content of less than 40% by weight, said calcium hydroxide composition being in the form of particles of calcium hydroxide having a BET specific surface area which is equal to or greater than 25 m²/g and a BJH total pore volume which is equal to or greater than 0.1 cm³/g;
mixing to said calcium hydroxide composition said first additive and said second additive.

The method of the invention can comprise several drying step, for example so as to ensure a water content of less than 10% by weight, advantageously less than 5% by weight of a calcium hydroxide based composition, prior adding and mixing a quantity of first additive and/or second additive.

For example, the method of the invention comprises [ ] the steps of:
preparing a calcium hydroxide composition having a moisture content of between 5 and 40% by weight, advantageously from 5 to 20% by weight, preferably from 5 to 15% by weight (the moist composition advantageously comprises less than 10% by weight, preferably less than 5% by weight of CaO, before the drying thereof), said composition being advantageously free or substantially free of first and second additives, and preferably comprising from 0.1 to 2% by weight (advantageously from 0.1 to 1% by weight, preferably from 0.1 to 0.5% by weight) diethyleneglycol and triethanolamine, with respect to the weight of quicklime expressed in hydrated form (Ca(OH)₂);
optionally drying said calcium hydroxide composition in order to obtain a dried composition having a free water content of less than 10% by weight, advantageously of less than 5% by weight, preferably of less than 3% by weight, in particular of less than 1% by weight;
at least a first step of adding and mixing to said composition of calcium hydroxide an amount of first additive which is selected from the group consisting of NaCl, Na₂SO₄, CaCl₂ and the mixtures thereof, and/or optionally, but advantageously an amount of second additive selected from the group consisting of NaOH, Na₂CO₃, NaHCO₃, and the mixtures thereof, so as to obtain a composition of calcium hydroxide mixed with first additive and/or second additive (in the preferred case in which the composition contains both first additive and second additive, it is possible for example to add the first additive first and then the second additive or to add the first additive premixed with the second additive or to add the second additive first and then the first additive. A premix in the form of dry particles or a solution of first additive and second additive is preferred, most preferably in the form of dry particles),
if the free water content of the composition is greater than 5% by weight, drying the composition to reduce the free water content thereof to less than 5% by weight, advantageously to less than 3% by weight, preferably to less than 1% by weight, and
a second step of optionally adding to said dried composition an amount of first additive which is selected from the group consisting of NaCl, Na₂SO₄, CaCl₂ and the mixtures thereof, and/or optionally, but advantageously an amount of second additive which is selected from the group consisting of NaOH, Na₂CO₃, NaHCO₃, and the mixtures thereof. This last addition is thus advantageously carried out in the form of dry particles, in particular in the form of a dry mixture of the first additive and the second additive.

In the method according to the invention, the first adding step and the second optional adding step are adapted so that the composition is a composition according to the invention as described above.

Advantageously, the additive is added to said prepared composition of calcium hydroxide, at least in part in the form of an aqueous solution or an aqueous suspension containing at least 25% by weight, advantageously at least 30% by weight, preferably at least 50% by weight of first additive and/or second additive and/or in the form of a pulverulent solid.

Preferably, the second additive which is selected from the group consisting of NaOH, Na₂CO₃, NaHCO₃, and the mixtures thereof is added to said prepared composition of calcium hydroxide, possibly after adding the first additive, at least in part in the form of an aqueous solution or an aqueous suspension containing at least 25% by weight, advantageously at least 30% by weight, preferably at least 50% by weight of second additive and/or in the form of a pulverulent solid.

According to advantageous details of the method according to the invention, the preparation method has one or the other of the following distinctive features:
the composition of calcium hydroxide and first additive and optionally second additive which is selected from the group consisting of NaOH, Na₂CO₃, NaHCO₃, and the mixtures thereof is subjected to an agglomeration and/or granulation step, before being subjected to a drying step for lowering the water content to less than 5%, and/or
to said prepared composition of calcium hydroxide, a moist or dried composition of first additive also comprising calcium hydroxide or calcium oxide is added, and/or
the drying step is carried out by placing the composition (before and/or after adding and mixing the first additive and/or the second additive) to be dried in contact with hot air, advantageously having a temperature of between 100° C. and 250° C., and/or
the first additive or the second additive is added to the calcium hydroxide composition consisting for more than 99% by weight of calcium hydroxide and water, at least in part in the form of an aqueous medium containing at least 25% by weight of additive selected form the group consisting of the said first additive, the said second additive, and combinations of said first and second additives. and/or
the first additive or the second additive is mixed in pulverulent solid form to the calcium hydroxide composition consisting for more than 99% by weight of calcium hydroxide and water. and/or
the step of preparing the calcium hydroxide composition consisting for more than 99% by weight of calcium hydroxide and water comprises a step of slacking quicklime with water in presence of 0.1 to 2% (advantageously from 0.1 to 1%, preferably from 0.1 to 0.5%) by weight of an agent selected from diethyleneglycol, diethanolamine and mixtures thereof, said weight being calculated with respect to the weight of the prepared calcium hydroxide composition. The slacking water being advantageously free of first additive and free of second additive.

The invention also relates to a method for treating fumes containing at least acid components (like HCl, SO₂, SO₃, HBr, etc.) by means of a composition according to the invention, wherein the fumes or flue gases to be treated are placed in contact with the composition according to the invention, in particular in the form of grains. The fumes or flue gases to be treated have advantageously a temperature below 400° C., preferably from 100° C. to 250° C., especially between 130° C. and 230° C.

### BRIEF DESCRIPTION OF THE DRAWINGS

Distinctive features and details of the invention will emerge from the following description of preferred embodiments of the invention, in which reference is made to the attached drawings. In said drawings,

FIG. 1 is a schematic view of a pilot plant for preparing a composition according to the invention, and

FIG. 2 is a schematic view of the device which is used to test grains of absorption agents according to the invention.

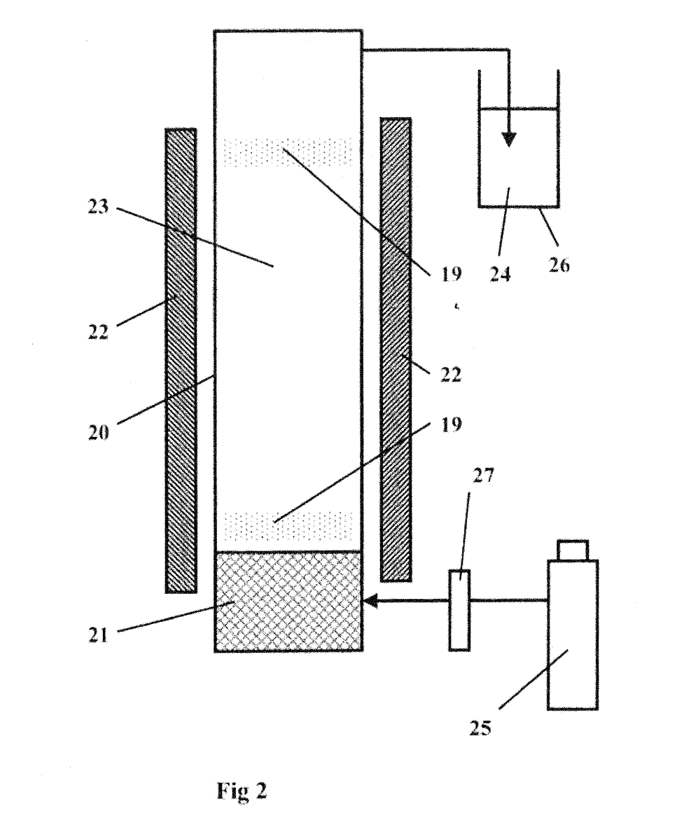

### DESCRIPTION OF EMBODIMENTS OF THE INVENTION

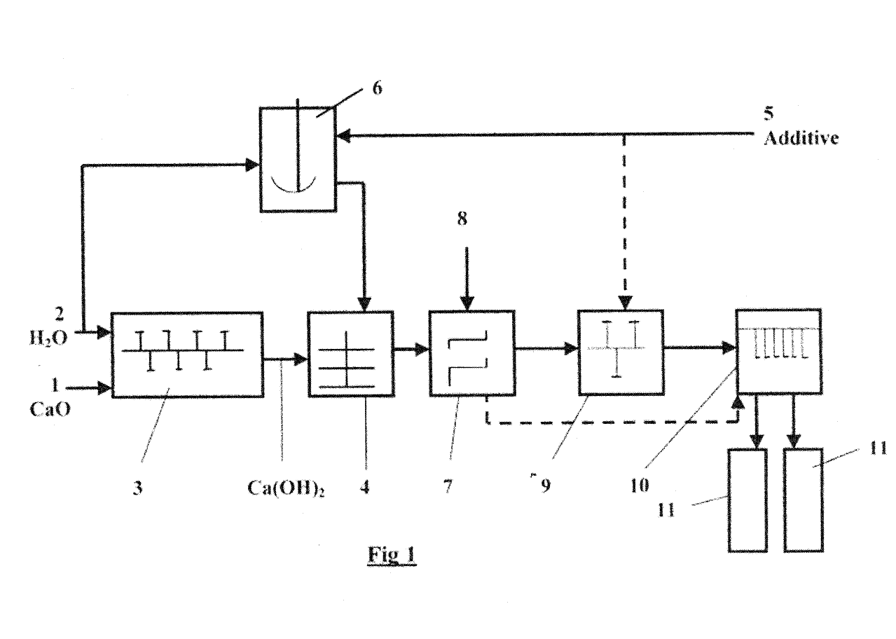

FIG. 1 is a schematic view of a plant for preparing a composition according to the invention. Said plant comprises a slaker having blades 3 which is supplied with quick lime (1) and water (2), optionally with an added agent (such as ethylene glycol, triethanol glycol, triethanolamine, etc., and the mixtures thereof). All the experiments were carried out on the basis of a ground quick lime having the same reactivity. (Increase in temperature of 60° C. in a time of between 1 and 4 minutes). The control of the rate of flow of quick lime and water is provided by feeders or feeding devices which make it possible to adjust the optimum moisture (free water) content in the hydrated lime at the output of the slaker. Said content is for example between 10% and 30% and is the subject of continuous monitoring of the free water content.

The moist hydrated lime is then transferred to a mixer and/or granulator (4) which is equipped with blades. Depending on the rotational speed of the blades (intensity of the mixing), the device makes it possible to mix the additives (5) coming from a tank, to put them in an aqueous suspension (tank 6) or to mix the additives in the dry and pulverulent state. The granulator (4) makes it possible to granulate the moist hydrated lime by means of agglomeration of the fine particles of calcium hydroxide. Advantageously, the additives are added in the form of an aqueous solution.

After incorporating and mixing the additives in solution or in the dry state (9) or after granulation (4), the composition according to the invention is then dried to reduce the free water content thereof to less than 2% by weight in a dryer (7) which is supplied with hot air (8).

The dry composition is either in the pulverulent or granulated state and is subjected to filtration by a filter or sieve (10) in order to separate fractions of the composition which have different particle sizes, then stored in silos (11).

### EXAMPLES

In this example, different calcium-hydroxide-based compositions have been used to treat fumes. The fumes to be treated came from a thermal power plant (2.5 MW output power), the sulphur content of the coal used in the plant was 1.3%. The fumes contained 1500-1800 mg SO₂/Nm³, with an average value of 1650 mg SO₂/Nm³. The moisture content of the fumes was approximately 12% by volume. The temperature of the fumes at the point where the absorbent was injected was between 150° C. and 210° C. with an average temperature of 180° C. The contact period of the particles of absorbent driven by the stream of fumes was from 2 to 5 seconds, to which must be added that of the contact in the region of the filter to recover the solid residues such as the residual calcium hydroxide, the calcium sulphates and sulphites and the fly ash originating from the combustion of the coal.

The SO₂ content was measured continuously for the fumes before and after contact with the absorbent.

The performance of the different absorbents was calculated based on values which were stabilised for 30 minutes. The rate of reduction in the acid gases and the rate of desulphurisation or dechlorination were calculated in the following manner:

Let [HCl]₀ and [SO₂]₀ be the HCl and SO₂ contents of the fumes before treatment, and let [HCl]_{f} and [SO₂]_{f} be the HCl and SO₂ contents of the fumes after treatment,

the rate of dechlorination (expressed in %) is equal to:

(([HCl]₀—[HCl]_{f})/[HCl]₀)×100, and

the rate of desulphurisation (expressed in %) is equal to:

(([SO₂]₀—[SO₂]_{f})/[SO₂]₀)×100.

The rate of use of the absorbents or the yield of solids is determined by the stoichiometries of the reactions of the hydrated lime with SO₂ and HCl [and thus by the ratio of Ca to S or Ca to 2HCl].

In order to compare the performance of compositions according to the invention with that of compositions not according to the invention, nine absorbents were prepared.

### Comparative Embodiments

### Absorbents I to VI

### Absorbent I: Hydrated Lime not According to the Invention—Comparative

This absorbent was prepared using the method described in EP0558522. The quick lime was slaked with a great excess of water containing ethylene glycol (the used quantity of ethylene glycol corresponding to 1% of the weight of the quicklime). Before drying, the moist calcium hydroxide had a free water content of 20%. After drying, the moisture content was less than 1% by weight. Before drying with hot air, the hydrated lime had a specific surface area of 39 m². The dry product had a water content of less than 1% by weight.

Absorbent II: Hydrated Lime with NaOH not According to the Invention

The quick lime is slaked in the same manner as for absorbent I. After slaking and before drying, an aqueous solution of soda (NaOH—soda concentration of 30% by weight) is mixed with the moist slaked lime. The mixture is then dried. The amount of soda added is adapted in order to obtain a soda concentration of 1.22% with respect to the dry weight of the composition. The dry product had a water content of less than 1% by weight.

Absorbent III: Hydrated Lime with NaOH Prepared According to the Method Described in WO2007/000433—Comparative—not According to the Invention

The quick lime is slaked with an aqueous solution containing soda. After slaking, the lime had a moisture content of 10%. The amount of soda added is adapted so that the lime has, after drying, an NaOH content of 1.22% by weight. The dry product had a water content of less than 1% by weight.

Absorbent IV: Hydrated Lime with NaCl not According to the Invention

The quick lime is slaked with an aqueous solution containing NaCl. After slaking, the lime had a moisture content of 10%. The amount of soda added is adapted so that the lime has, after drying, an NaCl content of 3% by weight. The hydrated lime had a specific surface area of less than 20 m²/g. The dry product had a water content of less than 1% by weight.

Absorbent V: Hydrated Lime with CaCl₂ not According to the Invention

The quick lime is slaked with an aqueous solution containing CaCl₂. After slaking, the lime had a moisture content of 10%. The amount of soda added is adapted so that the lime has, after drying, a CaCl₂ content of 3% by weight. The hydrated lime had a specific surface area of less than 20 m²/g. The dry product had a water content of less than 1% by weight.

Absorbent VI: Hydrated Lime with Na₂SO₄ not According to the Invention

The quick lime is slaked with an aqueous solution containing Na₂SO₄. After slaking, the lime had a moisture content of 10%. The amount of soda added is adapted so that the lime has, after drying, an Na₂SO₄ content of 3% by weight. The hydrated lime had a specific surface area of less than 20 m²/g. The dry product had a water content of less than 1% by weight.

### Examples of Absorbents According to the Invention

Absorbents VII to XII are embodiments according to the invention.

Absorbent VII: Hydrated Lime with NaOH and NaCl According to the Invention

This absorbent VII is prepared in the same manner as absorbent II, except for the fact that the solution of soda which was added to the moist slaked lime contained NaCl. The amount of NaCl added to the solution of soda was adapted so as to obtain an NaCl content of 8% with respect to the dry weight of the composition. The BET specific surface area of the lime is approximately 40 m²/g. The water content was less than 0.5% by weight.

Absorbent VIII: Hydrated Lime with NaCl and Na₂CO₃ According to the Invention

This absorbent VIII is prepared in the same manner as absorbent VII, except for the fact that

Na₂CO₃ is used instead of NaOH. The NaCl content of the dry product is 3%, whereas the Na₂CO₃ content of the dry product was approximately 10%. The specific surface area of the hydrated lime is approximately 40 m²/g. The water content was less than 0.5% by weight.

Absorbent IX: Hydrated Lime with NaCl and NaHCO₃ According to the Invention

This absorbent IX is prepared in the same manner as absorbent VII, except for the fact that NaHCO₃ is used instead of NaOH. The NaCl content of the dry product is 3%, whereas the NaHCO₃ content of the dry product was approximately 7%. The specific surface area of the hydrated lime is approximately 40 m²/g. The water content was less than 0.5% by weight.

Absorbent X: Hydrated Lime with Na₂CO₃ and CaCl₂ According to the Invention

This absorbent VII is prepared in a similar manner to absorbent VII, except for the fact that the amount of Na₂CO₃ and calcium chloride used was adapted so that the dry absorbent contains 5% Na₂CO₃ and 7% calcium chloride. The specific surface area of the hydrated lime is approximately 40 m²/g. The water content was less than 0.5% by weight.

Absorbent XI: Hydrated Lime with Na₂CO₃ and Na₂SO₄ According to the Invention

This absorbent XI is prepared in a similar manner to absorbent X, except for the fact that the amount of sodium carbonate and sodium sulphate used was adapted so that the dry absorbent contains 1.61% by weight of sodium carbonate and 13.24% by weight of sodium sulphate. The specific surface area of the lime was approximately 37 m²/g. The water content was less than 0.5% by weight.

Absorbent XII: Hydrated Lime with Na₂CO₃ and NaCl According to the Invention

This absorbent XII is prepared in a similar manner to absorbent VII, except for the fact that the amount of sodium carbonate and sodium chloride used was adapted so that the dry absorbent contains 3.45% by weight of sodium carbonate and 8.9% by weight of sodium chloride (corresponding to a total sodium content of 5% by weight, a content considered as being not effective according to the prior art). The specific surface area of the lime was approximately 38 m²/g. The water content was less than 0.5% by weight.

### Results of Tests

Table 1 below gives the rate of desulphurisation or the rate of reduction in SO₂, as well as the rate of use of the absorbents in %, taking into account a stoichiometric ratio of Ca to S of 2 for all the experiments from example 1.

TABLE 1

| | Rate of desulphurisation | Rate of use of |
|---|---|---|
| Absorbent | (in %) | the absorbent (in %) |
| I | 36 | 18 |
| II | less than 40 | less than 20 |
| III | less than 40 | less than 20 |
| IV | less than 40 | less than 20 |
| V | less than 40 | less than 20 |
| VI | less than 40 | less than 20 |
| VII (invention) | more than 50 | more than 25 |
| VIII (invention) | more than 60 | more than 30 |
| IX (invention) | more than 60 | more than 30 |
| X (invention) | more than 60 | more than 30 |
| XI (invention) | more than 60 | more than 30 |
| XII (invention) | more than 70 | more than 35 |

It can be seen from this table that the absorbents according to the invention (VII to XII) allow a rate of desulphurisation and rate of use which are greater than those of the comparative absorbents I to VI. The use of NaCl, CaCl₂ and Na₂SO₄ salts in combination with a hydrated lime having a BET surface area of more than 25 m²/g, and advantageously in the presence of Na₂CO₃ clearly had a synergistic effect on the desulphurisation. From the absorbents according to the invention, the absorbents comprising (a) hydrated lime, (b) NaHCO₃ and/or Na₂CO₃, and (c) NaCl and/or Na₂SO₄ and (d) water are preferred because they allow an improved rate of use of the absorbent of more than 50% with respect to the rate obtained for the hydrated lime having a large specific surface area or for absorbents II and III.

Absorbents I and VII to XII were granulated before being dried in order to study the absorption or capture properties of the grains. The grains had a substantially spherical shape having an average diameter by weight of approximately 3 mm.

These granular absorbents were tested in the following manner.

A specific quantity of grains of absorbent 19 were placed in a Pyrex glass column (20). Said grains were deposited on a layer of glass wool 21. Said grains form a fixed bed 23.

A known amount of SO₂ or HCl is inserted in the column (in the region of the layer of glass wool 21) by means of a flow meter having a needle 27. The gas to be captured comes from a cylinder 25. The temperature of the environment inside the column 20 is controlled by a heating jacket 22 (for example to a temperature of between 100° C. and 110° C.). The period of contact between the gas and the absorbent is approximately 30 minutes, whereas the amount of gas inserted in the column is adapted with respect to the stoichiometry of the reaction so as to have a ratio of Ca to S=1 or Ca to 2HCl=1. The acid gas which has not reacted with the absorbent is absorbed by bubbling (in the tank 26) in a solution of caustic soda in a known amount and strength (24). The assessment of the test (in order to determine the amount of SO₂ or HCl captured) is carried out by analysing the absorbent and by titrating the amount of residual soda.

Table 2 below gives the rates of desulphurisation and dechlorination (in %) using absorbents in the form of grains.

TABLE 2

| | BET specific | | Rate of |
|---|---|---|---|
| | surface area | Rate of | dechlorination |
| Absorbent | m²/g | desulphurisation (in %) | (in %) |
| I comparative | more than 30 | less than 60 | less than 70 |
| VII | more than 30 | more than 80 | more than 90 |
| VIII | more than 30 | more than 80 | more than 90 |
| IX | more than 30 | more than 80 | more than 90 |
| X | more than 30 | more than 80 | more than 90 |
| XI | more than 30 | more than 80 | more than 90 |
| XII | more than 30 | more than 80 | more than 90 |

The rates of desulphurisation and dechlorination obtained with the absorbents according to the invention are between 80 and 97%, which amounts to a rate of use of the lime of from 40 to 50% with a ratio of Ca to S or Ca to 2HCl of 1.

Tests with composition of the invention show that when using both additives, a synergistic effect can be achieved for the treatment fo flue gases or fumes, enabling an increased rate of use of the absorbent.

1. A dry or substantially dry composition for treating fumes, comprising:
more than 80% by weight of hydrated lime in the form of particles of calcium hydroxide having a BET specific surface area which is equal to or greater than 25 m²/g and a BJH total pore volume which is equal to or greater than 0.1 cm³/g;
a first additive selected from the group consisting of NaCl, Na₂SO₄, CaCl₂ and the mixtures thereof, the ratio by weight of said first additive to hydrated lime being comprised between 1:100 and 1:10,
from 1 to 10% by weight of a second additive selected from the group consisting of NaOH, Na₂CO₃, NaHCO₃ and the mixtures thereof, and
less than 5% by weight of water.

2. The composition of claim 1, comprising at least NaCl as first additive and at least Na₂CO₃ as second additive.

3. The composition of claim 1, comprising substantially only NaCl as first additive and substantially only Na₂CO₃ as second additive.

4. The composition of claim 1, in which the ratio by weight of said first additive to hydrated lime is comprised between 1:50 and 1:20, and which comprises from 1 to 5% by weight of said second additive.

5. The composition of claim 1, comprising less than 1% by weight water.

6. The composition of claim 1, in which at least 98% by weight of the composition consists of (a) hydrated lime in the form of particles of calcium hydroxide having a BET specific surface area which is equal to or greater than 25 m²/g and a BJH total pore volume which is equal to or greater than 0.1 cm³/g, (b) NaCl, and (c) Na₂CO₃ and/or NaHCO₃, and (d) water.

7. The composition of claim 1, in which at least 99% by weight of the composition consists of hydrated lime in the form of particles of calcium hydroxide having a BET specific surface area which is equal to or greater than 25 m²/g and a BJH total pore volume which is equal to or greater than 0.1 cm³/g, NaCl, Na₂CO₃ and water.

8. The composition of claim 1, in which the ratio by weight of first additive and second additive to hydrated lime in the form of particles of calcium hydroxide having a BET specific surface area which is equal to or greater than 25 m²/g and a BJH total pore volume which is equal to or greater than 0.1 cm³/g is comprised between 1:20 and 4:20.

9. The composition of claim 1, in which the hydrated lime in the form of particles of calcium hydroxide having a BET specific surface area which is equal to or greater than 25 m²/g and a BJH total pore volume which is equal to or greater than 0.1 cm³/g has a weight average particle size of less than 100 μm.

10. The composition of claim 1, which is at least partly in the form of grains having an average size by weight of between 0.5 mm and 7 mm.

11. The composition of claim 1, which is in the form of a mixture of calcium hydroxide particles having an average size by weight of less than 100 μm, a BET specific surface area which is equal to or greater than 25 m²/g and a BJH total pore volume which is equal to or greater than 0.1 cm³/g and of grains having an average size by weight of from 0.5 mm to 7 mm.

12. The composition of claim 1, in which the calcium hydroxide particles having a BET specific surface area which is equal to or greater than 25 m²/g and a BJH total pore volume which is equal to or greater than 0.1 cm³/g are prepared by slaking quick lime with water free of first additive and free of second additive for achieving slacked lime and by drying said slacked lime for achieving calcium hydroxide particles with a water content of less than 5% by weight.

13. The composition of claim 1, in which the calcium hydroxide particles having a BET specific surface area which is equal to or greater than 25 m²/g and a BJH total pore volume which is equal to or greater than 0.1 cm³/g have an outer surface, and in which at least 50% by weight of the first additive and at least 50% by weight of the second additive are contacting the outer surface of the said calcium hydroxide particles.

14. The composition of claim 1, in which the calcium hydroxide particles having a BET specific surface area which is equal to or greater than 25 m²/g and a BJH total pore volume which is equal to or greater than 0.1 cm³/g comprises from 0.1% to 1% by weight diethyleneglycol and/or triethanolamine.

15. A method for preparing a dry or substantially dry composition for treating fumes, comprising:
more than 80% by weight of hydrated lime in the form of particles of calcium hydroxide having a BET specific surface area which is equal to or greater than 25 m²/g and a BJH total pore volume which is equal to or greater than 0.1 cm³/g;
a first additive selected from the group consisting of NaCl, Na₂SO₄, CaCl₂ and the mixtures thereof, the ratio by weight of said first additive to hydrated lime being comprised between 1:100 and 1:10,
from 1 to 10% by weight of a second additive selected from the group consisting of NaOH, Na₂CO₃, NaHCO₃ and the mixtures thereof, and
less than 5% by weight water,
whereby said water content of less than 5% by weight is achieved by at least a drying step, and
whereby said method comprises at least the following preparation steps of:
preparing a calcium hydroxide composition consisting for more than 99% by weight of calcium hydroxide and water, said calcium hydroxide composition being substantially free of said first additive and said second additive, said calcium hydroxide composition having a moisture content of less than 40% by weight, said calcium hydroxide composition being in the form of particles of calcium hydroxide having a BET specific surface area which is equal to or greater than 25 m²/g and a BJH total pore volume which is equal to or greater than 0.1 cm³/g;
mixing to said calcium hydroxide composition said first additive and said second additive.

16. The method of claim 15, in which the said first additive and said second additive are added in a substantially dry particle form to the calcium hydroxide composition consisting for more than 99% by weight of calcium hydroxide and water.

17. The method of claim 15, which comprises at least a drying step selected from a) a drying step of the calcium hydroxide composition consisting for more than 99% by weight of calcium hydroxide and water, before adding the first additive or the second additive to said calcium hydroxide composition, and b) a drying step of the calcium hydroxide composition consisting for more than 99% by weight of calcium hydroxide and water, after being mixed with the first additive or the second additive to said calcium hydroxide composition.

18. The method of claim 15, in which the first additive or the second additive is added to the calcium hydroxide composition consisting for more than 99% by weight of calcium hydroxide and water, at least in part in the form of an aqueous medium containing at least 25% by weight of additive selected form the group consisting of the said first additive, the said second additive, and combinations of said first and second additives.

19. The method of claim 15, in which the first additive or the second additive is mixed in pulverulent solid form to the calcium hydroxide composition consisting for more than 99% by weight of calcium hydroxide and water.

20. The method of claim 15, in which the step of preparing the calcium hydroxide composition consisting for more than 99% by weight of calcium hydroxide and water comprises a step of slacking quicklime with water in presence of 0.1 to 1% by weight of an agent selected from diethyleneglycol, diethanolamine and mixtures thereof, said weight being calculated with respect to the weight of the prepared calcium hydroxide composition.

21. The method of claim 17, in which the composition of calcium hydroxide consisting for more than 99% by weight of calcium hydroxide and water and the first additive or the second additive are subjected to an agglomeration and/or granulation step, before being subjected to a drying step.

22. The method of claim 17, in which the drying step is carried out by placing the composition to be dried in contact with hot air having a temperature of between 100° C. and 250° C.

23. A method for treating fumes containing at least acid components, wherein the fumes to be treated are placed in contact at a temperature from 100° C. to 250° C. with a dry or substantially dry calcium hydroxide based composition for treating fumes, comprising:
more than 80% by weight of hydrated lime in the form of particles of calcium hydroxide having a BET specific surface area which is equal to or greater than 25 m²/g and a BJH total pore volume which is equal to or greater than 0.1 cm³/g;
a first additive selected from the group consisting of NaCl, Na₂SO₄, CaCl₂ and the mixtures thereof, the ratio by weight of said first additive to hydrated lime being comprised between 1:100 and 1:10,
from 1 to 10% by weight of a second additive selected from the group consisting of NaOH, Na₂CO₃, NaHCO₃ and the mixtures thereof, and
less than 5% by weight[ ] of water.

24. The method of claim 23, in which the said dry or substantially dry calcium hydroxide based composition comprises at least NaCl as first additive and at least Na₂CO₃ as second additive.

25. The method of claim 23, in which the said dry or substantially dry calcium hydroxide based composition comprises substantially only NaCl as first additive and substantially only Na₂CO₃ as second additive.

26. The method of claim 23, in which the said dry or substantially dry calcium hydroxide based composition comprises a sufficient amount of first additive, whereby the ratio by weight of said first additive to hydrated lime in the form of particles of calcium hydroxide having a BET specific surface area which is equal to or greater than 25 m²/g and a BJH total pore volume which is equal to or greater than 0.1 cm³/g is comprised between 1:50 and 1:20, and in which the dry or substantially dry calcium hydroxide composition comprises from 1 to 5% by weight of said second additive.

27. The method of claim 23, in which the said dry or substantially dry calcium hydroxide based composition comprises less than 1% by weight water.

28. The method of claim 23, in which at least 98% by weight of the said dry or substantially dry calcium hydroxide based composition consists of (a) hydrated lime in the form of particles of calcium hydroxide having a BET specific surface area which is equal to or greater than 25 m²/g and a BJH total pore volume which is equal to or greater than 0.1 cm³/g, (b) NaCl, and (c) Na₂CO₃ and/or NaHCO₃ and (d) water.

29. The method of claim 23, in which at least 99% by weight of the said dry or substantially dry calcium hydroxide based composition consists of hydrated lime in the form of particles of calcium hydroxide having a BET specific surface area which is equal to or greater than 25 m²/g and a BJH total pore volume which is equal to or greater than 0.1 cm³/g, NaCl, Na₂CO₃ and water.

30. The method of claim 23, in which the said dry or substantially dry calcium hydroxide based composition comprises a sufficient amount of first additive and of second additive, whereby the ratio by weight of first additive and second additive to hydrated lime in the form of particles of calcium hydroxide having a BET specific surface area which is equal to or greater than 25 m²/g and a BJH total pore volume which is equal to or greater than 0.1 cm³/g is comprised between 1:20 and 4:20.

31. The method of claim 23, in which the hydrated lime in the form of particles of calcium hydroxide having a BET specific surface area which is equal to or greater than 25 m²/g and a BJH total pore volume which is equal to or greater than 0.1 cm³/g has a weight average particle size of less than 100 μm.

32. The method of claim 23, in which the dry or substantially dry calcium hydroxide based composition is at least partly in the form of grains having an average size by weight of between 0.5 mm and 7 mm.

33. The method of claim 23, in which the dry or substantially dry calcium hydroxide based composition is in the form of a mixture of calcium hydroxide particles having an average size by weight of less than 100 μm, a BET specific surface area which is equal to or greater than 25 m²/g and a BJH total pore volume which is equal to or greater than 0.1 cm³/g and of grains having an average size by weight of from 0.5 mm to 7 mm.

34. The method of claim 23, in which the calcium hydroxide particles having a BET specific surface area which is equal to or greater than 25 m²/g and a BJH total pore volume which is equal to or greater than 0.1 cm³/g are prepared by slaking quick lime with water free of first additive and free of second additive for achieving slacked lime and by drying said slacked lime for achieving calcium hydroxide particles with a water content of less than 5% by weight.

35. The method of claim 23, in which the calcium hydroxide particles having a BET specific surface area which is equal to or greater than 25 m²/g and a BJH total pore volume which is equal to or greater than 0.1 cm³/g have an outer surface, and in which at least 50% by weight of the first additive and at least 50% by weight of the second additive are contacting the outer surface of the said calcium hydroxide particles.

36. The method of claim 23, in which the calcium hydroxide particles having a BET specific surface area which is equal to or greater than 25 m²/g and a BJH total pore volume which is equal to or greater than 0.1 cm³/g comprises from 0.1% to 1% by weight diethyleneglycol and/or triethanolamine.
